(19) United States
(12) Patent Application Publication
(10) Pub. No.: US 2015/0095247 A1
(43) Pub. Date: Apr. 2, 2015

(54) Classifying Fraud on Event Management Systems

(71) Applicant: Eventbrite, Inc., San Francisco, CA (US)

(72) Inventor: Paul Duan, San Francisco, CA (US)

(73) Assignee: Eventbrite, Inc., San Francisco, CA (US)

(21) Appl. No.: 14/044,770

(22) Filed: Oct. 2, 2013

(51) Int. Cl. G06Q 30/00

(52) U.S. Cl. CPC G06Q 30/0185
USPC 705/318

(57) ABSTRACT

In one embodiment, a method includes accessing a plurality of classified event profiles including a classification that identifies whether the corresponding classified event profile is associated with fraud or legitimate. The method also includes accessing a first cluster of classified event profiles each identified as being associated with fraud, and a second cluster of classified event profiles each identified as being legitimate. The method further includes determining a plurality of first sub-clusters of classified event profiles from the first cluster of classified event profiles, and a plurality of second sub-clusters of classified event profiles from the second cluster of classified event profiles. The method still further includes conditioning a plurality of fraud-detection algorithms, each fraud-detection algorithm corresponding to a particular specified parameter, and each fraud-detection algorithm being conditioned using a first sub-cluster of classified event profiles and a second sub-cluster of classified event profiles.

### TECHNICAL FIELD

The present disclosure generally relates to online event management systems and fraud detection systems.

### BACKGROUND

Many websites allow users to conduct a variety of actions online, such as viewing content, writing reviews, ordering items, purchasing tickets, etc. These websites often present the user with a plurality of actions to choose from and allow the user to select the type of action he would like to perform. Once the action is selected, the website typically redirects the client system of the user to a webpage where the action can be completed. For example, some websites allow users to organize events using an online event management system. An online event management system may allow an event organizer to organize and manage various aspects of an event, such as, for example, managing attendee registrations and selling tickets, promoting the event, and managing attendee check-in at the event. An online event management system may also allow users to view event profiles, register for events, and purchase tickets for events. Online systems, such as online event management systems, can typically be accessed using suitable browser clients (e.g., MOZILLA FIREFOX, GOOGLE CHROME, MICROSOFT INTERNET EXPLORER).

Some users of an online event management system may attempt to improperly use the system, such as by violating the terms of services of the system or by using the system to commit illegal acts. One type of improper use is creating event listings that contain spam or other improper advertisements. For example, a user may create an online event listing for a fake event and then use the event listing to display an advertisement for a product (e.g., erectile dysfunction drugs, nutraceuticals, pornography). Another type of improper use is creating event listings in order to make fraudulent financial transactions. For example, a user may create an online event listing for a fake event and then use stolen credit cards to purchase tickets to the fake event. The user may then request that the system pay out money to the user for the fraudulently purchased tickets. If the online event management system pays out the money before the purchases can be verified the system may lose money when the fraudulent purchases are declined by the credit card processor.

### BRIEF DESCRIPTION OF THE DRAWINGS

FIG. 1 illustrates an example system for implementing an online event management system and an online fraud detection system.

FIG. 2 illustrates an example method for evaluating event profiles for fraud.

FIG. 3 illustrates an example data set configuration for use in a system for classifying fraud on an event management system.

FIG. 4 illustrates an example method for classifying fraud on an event management system.

FIG. 5 illustrates an example computer system.

### DESCRIPTION OF EXAMPLE EMBODIMENTS

### System Overview

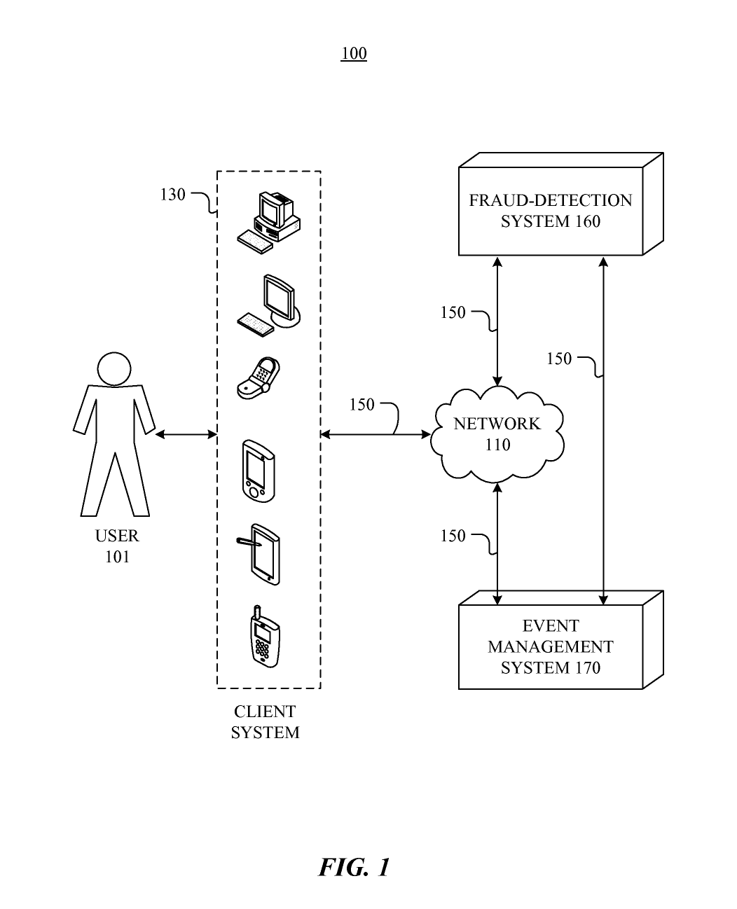

FIG. 1 illustrates an example system 100 for implementing an online event management system and a fraud detection system. System 100 includes a user 101, a client system 130, a fraud-detection system 160, and an event management system 170 connected to each other by a network 110. Although FIG. 1 illustrates a particular arrangement of user 101, client system 130, fraud-detection system 160, event management system 170, and network 110, this disclosure contemplates any suitable arrangement of user 101, client system 130, fraud-detection system 160, event management system 170, and network 110. As an example and not by way of limitation, two or more of client system 130, fraud-detection system 160, and event management system 170 may be connected to each other directly, bypassing network 110. As another example and not by way of limitation, two or more of client system 130, fraud-detection system 160, and event management system 170 may be physically or logically co-located with each other in whole or in part. As yet another example, one or more fraud-detection systems 160 may be physically or logically co-located with one or more event management systems 170 in whole or in part. Moreover, although FIG. 1 illustrates a particular number of users 101, client system 130, fraud-detection systems 160, event management systems 170, and networks 110, this disclosure contemplates any suitable number of users 101, client systems 130, fraud-detection systems 160, event management systems 170, and networks 110. As an example and not by way of limitation, system 100 may include multiple users 101, client systems 130, fraud-detection systems 160, event management systems 170, and networks 110.

In particular embodiments, an event management system 170 may be a network-addressable computing system that can host one or more event organization and management systems. An event management system 170 may generate, store, receive, and transmit event-related data, such as, for example, event profiles, event details, event history details, event registration details, event organizer details, event attendee details, ticket purchase details, and event displays. An event management system 170 may be accessed by the other components of system 100 either directly or via network 110. In particular embodiments, fraud-detection system 160 may be a network-addressable computing system that can host one or more pricing engines or modules. Fraud-detection system 160 may generate, store, receive, and transmit fraud-risk-related information, such as, for example, event-related data, event organizer information, purchase information, and other data relevant to detecting fraudulent events. Fraud-detection system 160 may be accessed by the other components of system 100 either directly or via network 110. Fraud-detection system 160 may be an independent system or a subsystem of event management system 170.

In particular embodiments, one or more users 101 may use one or more client systems 130 to access, send data to, and receive data from an event management system 170. A client system 130 may access an event management system 170 directly, via network 110, or via a third-party system. A client system 130 may be any suitable computing device, such as, for example, a personal computer, a laptop, a cellular phone, a smart phone, or a computing tablet. In particular embodiments, one or more users 101 may be an automated system, such as, for example, a computer program, an internet bot, another type of automated system, or two or more such systems.

Network 110 may be any suitable communications network. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Connections 150 may connect client system 130, fraud-detection system 160, and event management system 170 to communication network 110 or to each other. This disclosure contemplates any suitable connections 150. In particular embodiments, one or more connections 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)) or optical (such as for example Synchronous Optical Network (SONET) or Synchronous Digital Hierarchy (SDH)) connections. In particular embodiments, one or more connections 150 each include an ad hoc network, an intranet, an extranet, a VPN, a LAN, a WLAN, a WAN, a WWAN, a MAN, a portion of the Internet, a portion of the PSTN, a cellular telephone network, another connection 150, or a combination of two or more such connections 150. Connections 150 need not necessarily be the same throughout system 100. One or more first connections 150 may differ in one or more respects from one or more second connections 150.

### Event Management Systems

In particular embodiments, an event management system 170 may allow users to create, organize and manage events. An event may be, for example, a party, a concert, a conference, a sporting event, a fundraiser, a networking event, or a live performance. Events may occur online (such as, for example, a web-based seminar) and offline (such as, for example, a live seminar in a lecture hall). An online event management system may allow an event organizer to organize and manage various aspects of an event, such as, for example, creating event profiles, managing attendee registrations and selling tickets, managing funds from ticket sales, promoting the event, and managing attendee check-in at the event. An online event management system may also allow event attendees to view and manage various aspects of registering for an event, such as, for example, viewing event profiles, viewing event history information, registering for events, and purchasing tickets for events. As an example and not by way of limitation, a first user may use event management system 170 to create and organize an event. The first user may create an event profile for the event and input event information or event parameters associated with the event. As used herein, the terms “event information” and “event parameter” may be used interchangeably to refer to data in an event profile describing one or more aspects of or related to an event. The event profile may be viewable in one or more webpages or other content served by event management system 170. One or more second users may then use event management system 170 to register for the event. The second users may view an event profile associated with the event and then register or purchase tickets for the event. Although this disclosure describes particular types of events, this disclosure contemplates any suitable types of events. Moreover, although this disclosure describes organizing and managing particular aspects of an event, this disclosure contemplates organizing and managing any suitable aspects of an event. Furthermore, although this disclosure uses the term “ticket,” this disclosure is applicable to events that do not use physical tickets and even ticketless events where attendees merely register for the event. Thus, unless context suggests otherwise, the term “ticket” (whether alone or when used in conjunction with other terms) may be considered synonymous with “registration.”

In particular embodiments, an event management system 170 may have an event profile associated with each event managed by the system. An event profile may be accessed and displayed by any suitable client system 130. An event profile may include event information describing the event title, the event date/time, the event category or type, the event details, the description of the event, the event cost or ticket price for the event, the event organizer, the event promoter, the geographic location of the event, the venue for the event, a venue capacity, the performer for the event, the number of tickets available for the event, the type/class of tickets available for the event, the ticket identifiers, the event attendees, the attendee check-in status of each event attendee, the ticket-selling window (a start time and an end time during which tickets can be sold), purchase information for the event, an attendee list for the event, references to additional information (such as, for example, hypertext links to resources related to or describing the event, and the like), privacy settings for the event profile, or other suitable event information. Although this disclosure describes particular types of event information, this disclosure contemplates any suitable types of event information.

In particular embodiments, the event profile may include an event attendee list. The event attendee list may include, for example, information describing the attendees registered to attend the event, include the attendee's name, phone number, mailing address, email address, IP address, device identifier, purchase information, ticket order information, ticket information, check-in status, and other suitable attendee information. Each attendee may be assigned one or more tickets, and each ticket may have a unique ticket identifier. A ticket identifier may be an identification number, a barcode, a 2D barcode, a QR code, or another suitable unique identifier. Although this disclosure describes particular types of information associated with an event attendee list, this disclosure contemplates any suitable types of information associated with an event attendee list.

In particular embodiments, the event profile may include a total number and type of tickets that are available for the event. The type of tickets available for an event may include, for example, premium tickets, general admission tickets, reserved seating tickets, another suitable type of tickets, or two or more such types of tickets. There may be various numbers of each ticket type available for the event. The number of tickets available for an event may be based on a variety of factors. As an example and not by way of limitation, the event organizer or venue owner may specify a particular number of tickets that may be sold for the event. As another example and not by way of limitations, the number of tickets that may be sold may be based on the size or capacity of the venue. Although this disclosure describes particular numbers and types of tickets that are available for an event, this disclosure contemplates any suitable numbers and types of tickets that are available for an event.

In particular embodiments, the event profile may include purchase information for the event. A purchase information may include, for example, a user 101's name, phone number, mailing address, email address, billing address, payment information, ticket order information, credit card information, bank account number, PAYPAL username, cash payment information, money transfer information, address verification system score for the payment, validity information for the payment, or other suitable purchase information. Although this disclosure describes particular types of purchase information, this disclosure contemplates any suitable types of purchase information.

In particular embodiments, each user 101 of event management system 170 may have an event history information associated with the user 101. Event history information may include event information and purchase information associated with one or more events a user 101 has attended or has registered to attend, as well as purchase history information associated with each event. Event history information may also include event information associated with one or more event profiles a user 101 has created, organized, and managed. Although this disclosure describes particular event history information, this disclosure contemplates any suitable event history information.

In particular embodiments, the event management system 170 may use a unique client identifier (ID) to identify a user 101. As an example and not by way of limitation, the event management system 170 may assign a unique device ID to each client system 130. The event management system 170 may assign each client system 130 with an unique client identifier based on the IP address of the client system 130, tracking cookies on the client system 130 (which may be appended to HTTP requests transmitted by the client system 130), the serial number or asset tag of the client system 130, or other suitable identifying information. As another example and not by way of limitation, the event management system 170 may assign a unique user ID to each user 101, which the user may provide to the event management system 170 via a client system 130. The event management system 170 may assign each user 101 with a username and password that the user 101 can input into client system 130, which then transmits the username and password to the event management system 170. In particular embodiments, the event management system 170 can use the unique client identifier (such as, for example, a device ID or user ID) to determine that the user 101 is accessing the system. As yet another example and not by way of limitation, the event management system 170 may assign a unique client identifier to each attendee of an event. Although this disclosure describes particular types of unique client identifiers, this disclosure contemplates any suitable types of unique client identifiers. Moreover, although this disclosure describes using client identifiers in a particular manner, this disclosure contemplates using client identifiers in any suitable manner.

In particular embodiments, the event management system 170 may maintain an event management account for a user 101. The event management account may contain a variety of information about the user 101. As an example and not by way of limitation, an event management account may contain personal information (such as, for example, name, sex, location, interests), social network information (such as, for example, friend connections, personal information about user 101's friends), financial information (such as, for example, income, credit history), event history information (such as, for example, the type, data, cost, venue, performers, geographic location of the events a user 101 has organized, registered for, or attended), or other suitable information related to the user 101. Although this disclosure describes event management accounts containing particular types of information about a user 101, this disclosure contemplates event management accounts containing any suitable information about a user 101.

In particular embodiments, an event management system 170 may use a “shopping cart” model to facilitate event registration. As an example and not by way of limitation, event management system 170 may present a user 101 with a plurality of event profiles. The user 101 may select one or more of the events to register for. When the user 101 selects an event profile on event management system 170, the event management system 170 may metaphorically add that item (e.g., registration for the event) to a shopping cart. If appropriate, the user 101 may also select a ticket type or a number of tickets for the event. When the user 101 is done selecting event profiles, then all the items in the shopping cart may be “checked out” (i.e., ordered) when the user 101 provides purchase information (and possibly shipment information). In some embodiments, when a user 101 selects an event profile, then that event profile may be “checked out” by automatically prompting the user for purchase information, such as, for example, the user's name and purchase information. The user 101 then may be presented with a registration webpage that prompts the user for the user-specific registration information to complete the registration. That webpage may be pre-filled with information that was provided by the user 101 when registering for another event or when establishing an event management account on the event management system 170. The information may then be validated by the event management system 170, and the registration may be completed. At this point, the user 101 may be presented with a registration confirmation webpage or a receipt that displays the details of the event and registration details. Event management system 170 may also charge or withdraw funds from a financial account associated with user 101 based on the purchase information provided by the user 101. The “shopping cart” model may be facilitated by a client system 130 operating offline from event management system 170. Although this disclosure describes particular means for registering for events and purchasing tickets, this disclosure contemplates any suitable means for registering for events and purchasing tickets.

In particular embodiments, an event management system 170 may facilitate paying out funds to an event organizer The event management system 170 may collect funds from ticket buyers, hold these funds, and transfer some or all of the funds to the event organizer In particular embodiments, one or more users 101 may buy one or more tickets on event management system 170, and the system may collect some or all of the funds associated with these ticket sales. As an example and not by way of limitation, nine users 101 may purchase tickets to a concert using event management system 170. If the tickets cost $100 each, then event management system 170 would have collected $900 from the users 101. In particular embodiments, event management system 170 may then pay out funds from ticket sales to an event organizer As an example and not by way of limitation, event management system 170 may transfer or deposit the funds into a financial account associated with the event organizer. Event management system 170 may pay out some or all of the funds. For example, if each $100 ticket includes an $8 service charge, event management system 170 may only pay out $92 per ticket to the event organizer In particular embodiments, event management system 170 may pay out funds to the event organizer at particular times. As an example and not by way of limitation, event management system 170 may pay out funds to an event organizer after each ticket sale. As another example and not by way of limitation, event management system 170 may pay out funds in response to a request from the event organizer. The event organizer may request to withdraw all funds from his account. Alternatively, the event organize may request to withdraw less than all the funds. For example, if event management system 170 has collected $900 from selling tickets, the event organizer may request that the system pay out only $700. In particular embodiments, event management system 170 may hold funds for a particular time period. Event management system 170 may hold these funds for a time sufficient to allow payments to clear or be verified. Payments may be verified or cleared by a bank, a credit card issuer, a credit card processor, or a fraud-detection system 160. If the funds used to purchase a ticket have not yet cleared, event management system 170 may hold the funds and not allow these funds to be paid out. Although this disclosure describes a particular means for paying out funds to an event organizer, this disclosure contemplates any suitable means for paying out funds to an event organizer.

### Fraud Detection Systems

Some users of an online event management system may attempt to improperly use the system, such as by violating the terms of services of the system or by using the system to commit illegal acts. One type of improper use is creating event profiles that contain spam or other improper advertisements. For example, a user may create an online event profile for a fake event and then use the event profile to display an advertisement for a product (e.g., erectile dysfunction drugs, nutraceuticals, pornography). Another type of improper use is creating event profiles in order to make fraudulent financial transactions. For example, a user may create an online event profile for a fake event. The user, and possibly one or more accomplices, may then use stolen credit cards to purchase tickets to the fake event. The user may then request that the system pay out money to the user for the fraudulently purchased tickets. If the online event management system pays out the money before the purchases can be verified (such as, for example, by a credit card processor, a credit card issuer, or a fraud detection system) the system may lose money when the fraudulent purchases are identified by the rightful owners of the stolen credit cards. In this case, there may be a chargeback on the purchase, where the online event management system may have to pay the fraudulently charged funds back to the rightful owner. Furthermore, funds already paid out to the fraudster cannot typically be recovered, resulting in an overall loss. Additional losses may result from chargeback fees.

In particular embodiments, a fraud-detection system 160 may evaluate one or more event profiles for potential or actual fraud. Fraud-detection system 160 may be an independent system or a subsystem of event management system 170. Fraud-detection system 160 may access event profiles and associated event information and purchase information on event management system 170 and analyze the event profiles for improper, fraudulent, or illegal use. Although this disclosure describes particular methods for evaluating event profiles for fraud, this disclosure contemplates any suitable methods for evaluating event profiles for fraud. Moreover, although this disclosure describes particular methods for evaluating event profiles for fraud, this disclosure contemplates using the same methods for evaluation the event parameters of an event profile for fraud.

In particular embodiments, an event profile may be evaluated for fraud by calculating a fraud score for the event profile. A fraud score may represent the probability an event profile is fraudulent or is associated with fraud, the percentile rank of the risk of fraud associated with the event profile in relation to other event profiles, or other suitable scoring representations. As an example and not by way of limitation, fraud-detection system 160 may analyze a set of event profiles for fraud and calculate a preliminary fraud value associated with the risk of fraud for each event profile. Fraud-detection system 160 may then sort the event profiles by preliminary fraud value and calculate a percentile rank associate with each event profile or preliminary fraud value. The percentile ranks may then be used as the fraud scores for the event profiles. As another example and not by way of limitation, fraud-detection system 160 may analyze a set of event profiles and determine the mean, standard deviation, or normalized values for particular types of event information and purchase information. Fraud-detection system 160 may then calculate the deviation of each event profile from these mean or nominal values, such that an event profile with more or larger deviations may have a higher fraud score than an event profile with fewer or smaller deviations. For example, if the nominal value for a geographic location of an event is equal to “United States,” then event profiles with geographic locations equal to “Nigeria” may have high fraud scores than event profiles with geographic locations equal to “United States.” As another example, if the mean credit card decline rate for ticket purchases is 8% with a standard deviation of ±4%, then an event profile with a credit card decline rate of 40% may have a high fraud score. Although this disclosure describes using particular methods for scoring the risk of fraud associated with an event profile, this disclosure contemplates using any suitable methods for scoring the risk of fraud associated with an event profile.

In particular embodiments, fraud-detection system 160 may calculate a fraud score for an event profile based on a variety of factors, such as, for example, event information associated with the event profiles, purchase information associated with the event profile, the amount of funds to be paid out to the event organizer, other suitable event information, or two or more such factors. The following is an example algorithm that fraud-detection system 160 could use to calculate a fraud score:

f_{fraud}=f(E₁, . . . , Eₙ, P₁, . . . , P^{m}, R)

where:
f_{fraud} is the fraud score for the event profile,
E₁, . . . , Eₙ are event information 1 through n,
P₁, . . . , Pₘ are purchase information 1 through m
R is the amount at-risk, which is the amount of funds to be paid out to the event organizer

Although this disclosure describes calculating a fraud score using a particular algorithm, this disclosure contemplates calculating a fraud score using any suitable algorithm. Moreover, although this disclosure describes calculating a fraud score using particular variables that represent particular information, this disclosure contemplates calculating a fraud score using any suitable variables representing any suitable information.

In particular embodiments, fraud-detection system 160 may evaluate an event profile for fraud at particular times. Fraud detection may be in real-time or post-facto. As an example and not by way of limitation, fraud-detection system 160 may evaluate an event profile for fraud when the event profile is created by an event organizer As another example and not by way of limitation, fraud-detection system 160 may evaluate an event profile for fraud when the event organizer makes a request to pay out funds. As yet another example and not by way of limitation, fraud-detection system 160 may evaluate an event profile for fraud periodically, such as once an hour, once a day, or another suitable period. In particular embodiments, fraud detection system may evaluate a set of event profiles for fraud in a particular order or sequence. Fraud-detection system 160 may evaluate one or more event profiles individually, in parallel, in batches, in whole, or by other suitable amounts. Although this disclosure describes evaluating event profiles at particular times, this disclosure contemplates evaluating event profiles at any suitable time.

In particular embodiments, fraud-detection system 160 may evaluate an event profile for fraud based on the event information associated with the event profile. Event information may include information describing the event date, type, cost, organizer, promoter, geographic location, venue, performer, attendees, and other suitable event information. Event information may also include information describing the event organizer, such as, for example, the event organizer's name, email, contact information, location, IP address, reputation, financial information, credit score, bank account number, payment history, and other suitable information about the event organizer In particular embodiments, fraud-detection system 160 may evaluate an event profile for fraud based on the location of the event. Events in particular locations or countries may be more likely to be fraudulent than events in other locations or countries. The location of an event may be inputted by an event organizer when he creates an event profile on event management system 170. As an example and not by way of limitation, events located in the United States or the European Union may have lower fraud scores than events located in various African nations or former Eastern Bloc countries that are known to be fraud risks. As another example and not by way of limitation, events located in unknown or imaginary locations may have higher fraud scores than events located in known locations. An event profile with a location of “Arvandor,” which is a mythical location, may have a higher fraud score than an event profile with a location of “Golden Gate Park,” which is a real location. In particular embodiments, fraud-detection system 160 may evaluate an event profile for fraud based on the location of the event organizer of the event. Event organizers in particular locations or countries may be more likely to create fraudulent event profiles than event organizers in other locations or countries. The location of an event organizer may be determined by querying the event organizer, from the event organizer's financial or personal information, by examining the IP address of the event organizer when he accesses event management system 170, or by other suitable methods. As an example and not by way of limitation, an event profile with an event organizer from Romania may have a higher fraud score than an event profile with an event organizer from the United States, where event organizers in particular foreign countries may be more likely to create fraudulent event profiles. As another example and not by way of limitation, an event profile with an event organizer in Rikers Island Prison Complex may have a higher fraud score than an event profile with an event organizer who is not in prison, where event organizers in prison may be more likely to create fraudulent event profiles. In particular embodiments, fraud-detection system 160 may evaluate an event profile for fraud based on the reputation of the event organizer Event organizers who have previously created non-fraudulent event profiles may be less likely to create fraudulent event profiles in the future. Similarly, event organizers who have previously created fraudulent event profiles may be more likely to create fraudulent event profiles. Furthermore, new users 101 of event management system 170 may be more likely to create fraudulent event profiles than users 101 with a history of using the system. As an example and not by way of limitation, an event profile with an event organizer who has a history of creating non-fraudulent event profiles may have a lower fraud score than an event profile with an event organizer who has no history of creating event profiles. In particular embodiments, fraud-detection system 160 may evaluate an event profile for fraud based on the payment history of the event organizer The payment history of an event organizer may include purchase information for one or more event profiles. The payment history of the event organizer may include the date, time, amount, and other suitable purchase information regarding prior pay outs to the organizer The payment history of the event organizer may also include the charge-back rate on any ticket payments that were paid out to the organizer Event organizers who have previously withdrawn funds may be less likely to create fraudulent event profiles than event organizers who are withdrawing funds for the first time. Moreover, event organizer who have previously withdrawn funds and had low charge-back rates are less likely to create fraudulent event profiles. As an example and not by way of limitation, an event profile with an event organizer who has had funds paid out to him several times previously may have a lower fraud score than an event profile with an event organizer who has not yet been paid out any funds. As another example and not by way of limitation, an event profile with an event organizer who has sold tickets associated with credit card payments and experienced a 0% charge-back rate may have a lower fraud score than an event profile with an event organizer who withdrew funds once previously and experienced a 50% charge-back rate. Although this disclosure describes evaluating an event profile for fraud based on particular event information, this disclosure contemplates evaluating an event profile for fraud based on any suitable event information.

In particular embodiments, fraud-detection system 160 may evaluate an event profile for fraud based on the purchase information associated with the event profile. Purchase information may include the address verification system code for the payments for the event, the credit cards and credit-card types used to pay for the event, the decline rate for the credit cards, the use ratio (i.e., orders per card) of the credit cards, the locations of payers, the IP addresses of the payers, the use ratio of the IP addresses, the number of prior payouts to the event organizer, the amount of prior payouts to the event organizer, and other suitable purchase information. In particular embodiments, fraud-detection system 160 may evaluate an event profile for fraud based on the address verification system codes (AVS codes) returned by the credit card processor for the payments for the event. When a user 101 purchases a ticket online using a credit card, a credit card processor may analyze the address information provided by the user 101 and compare it to the address of record for that credit card. The credit card processor may then determine that the address if a full match, a partial match, or a mismatch. Credit card charges that are full matches are less likely to be fraudulent than charges that are partial matches, which are less likely to be fraudulent than charges that are mismatches. Fraud-detection system 160 may look at the AVS scores for all tickets purchased for an event profile. Event profiles with worse AVS scores (i.e., more partial matches and mismatches) may have higher fraud scores. As an example and not by way of limitation, an event profile with an AVS score of 0.84 (which is a good score) may have a lower fraud score than an event profile with an AVS score of 0.99 (which is a poor score). In particular embodiments, fraud-detection system 160 may evaluate an event profile for fraud based on the payment or credit card decline rate for the payments for the event. Credit cards that have been stolen are more likely to be declined. Fraud-detection system 160 may access all of the credit card transactions associated with an event profile and calculate a credit card decline rate for the event profile. As an example and not by way of limitation, an event profile with an 8% decline rate may have a lower fraud score than an event profile with a 42% decline rate. In particular embodiments, fraud-detection system 160 may evaluate an event profile for fraud based on the locations of the payers of the payments for the event. Payers in particular locations or countries may be more likely to make fraudulent payment (such as, for example, by using stolen credit cards) than payers in other locations or countries. The location of a payer may be determined by querying the payer, from the payer's financial or personal information, by examining the IP address of the payer when he accesses event management system 170, or by other suitable methods. As an example and not by way of limitation, an event profile with several payers from Indonesia, where credit card fraud may be rampant, may have a higher fraud score than an event profile with payers only from the United States. In particular embodiments, fraud-detection system 160 may evaluate an event profile for fraud based on the credit cards used to pay for the event and the use ratio of the credit cards. Payers who use a particular credit card multiple times to buy tickets for an event may be more likely to be using a stolen credit card than payers who are only using their credit cards once per event. Fraud-detection system 160 may access all the credit card transaction associated with an event profile, identify any credit cards that were used multiple times, and calculate a credit card use ratio for the event profile. As an example and not by way of limitation, an event profile with a credit card use ratio of 4.1 (i.e., each credit card was used an average of 4.1 times to purchase tickets for the event) may have a higher fraud score than an event profile with a credit card use ratio of 1.3. In particular embodiments, fraud-detection system 160 may evaluate an event profile for fraud based on the IP addresses used to make payments for the event and the use ratio of the IP addresses. Payers who are using the same IP address for several ticket orders for an event may be more likely to be using a stolen credit card than payers who place a single ticket order from a single IP address. As an example and not by way of limitation, a payer with seven stolen credit cards may access event management system 170 from a client system 130, wherein the client system 130 has a particular IP address associated with it. The payer may then use each stolen credit card once to purchase one ticket for the event. However, the IP address associated with each purchase may be same. Consequently, multiple transactions coming from the same IP address may be more likely to be fraudulent. Fraud-detection system 160 may access all the IP addresses associated with ticket purchases for an event profile, identify any IP addresses that were used multiple times, and calculate an IP address use ratio for the event profile. As an example and not by way of limitation, an event profile with an IP use ratio of 6.0 (i.e., each IP address was used an average of 6.0 times to purchase tickets for the event) may have a higher fraud score than an event profile with an IP address use ration of 1.2. In particular embodiments, fraud-detection system 160 may evaluate an event profile for fraud based on the number of prior payouts to the event organizer of the event. An event profile with an event organizer who has previously withdrawn funds may be less likely to be fraudulent than an event profile with an event organizer who has yet to withdraw funds. As an example and not by way of limitation, an event profile with an event organizer who has had funds paid out to him several times previously may have a lower fraud score than an event profile with an event organizer who has not yet been paid out any funds. In particular embodiments, fraud-detection system 160 may evaluate an event profile for fraud based on the amount of the prior payouts to the event organizer of the event. An event profile with an event organizer who has previously received a large amount of funds may be less likely to be fraudulent than an event profile with an event organizer who has withdrawn less funds. As an example and not by way of limitation, an event profile with an event organizer who has had $10,000 in funds paid out to him may have a lower fraud score than an event profile with an event organizer who has not yet has any funds paid out. Although this disclosure describes evaluating an event profile for fraud based on particular event information or purchase information, this disclosure contemplates evaluating an event profile for fraud based on any suitable event information or purchase information.

In particular embodiments, fraud-detection system 160 may evaluate an event profile for fraud based on the amount of funds to be paid out to an event organizer The amount of funds to be paid out may also be known as the amount “at-risk.” The amount at-risk may be evaluated on an absolute basis or a percentile basis. Event management system 170 may automatically pay out some or all of the funds associated with an event profile at a specific time period. As an example and not by way of limitation, event management system 170 may pay out the current balance of funds associated with an event profile on a weekly basis to the event organizer Alternatively, event management system 170 may receive a request to pay out some or all of the funds associated with an event profile to the event organizer As an example and not by way of limitation, the event organizer may transmit a request to withdraw all funds collected from ticket sales for an event. As another example and not by way of limitation, the event organizer may transmit a request to withdraw a fraction of the funds collected from tickets sales for the event. An event profile with an event organizer requesting a pay out of a large amount of funds or a large fraction of funds available may be more likely to be fraudulent than an event profile with an event organizer requesting a pay out of less funds or a smaller fraction of funds available. As an example and not by way of limitation, an event profile with an event organizer who is requesting to withdraw $100,000 may have a higher fraud score than an event profile with an event organizer who is requesting to withdraw $100. Alternatively, an event profile with an event organizer requesting a pay out of a large amount of funds or a large fraction of funds available may not necessarily be more likely to be fraudulent, however the larger pay-out request presents a higher risk to the operator of the event management system 170. In particular embodiments, fraud-detection system 160 may evaluate an event profile based on the monetary risk posed by the amount of funds to be paid out to an event organizer. As an example, a request for $100,000 from a trusted event organizer may have the same fraud score as a request for $1000 from an unknown event organizer

In particular embodiments, fraud-detection system 160 may approve or deny pay-out requests based on the fraud score of an event profile. Fraud-detection system 160 may receive a request to pay out funds to an event organizer Fraud-detection system 160 may then determine a fraud score for that event profile. If the fraud score for the event profile is greater than a threshold fraud score, then fraud-detection system 160 may deny the request to pay out funds. As an example and not by way of limitation, if the fraud score for the event profile is in the 98th percentile or higher, fraud-detection system 160 may automatically deny the request to pay out funds. However, if the fraud score for the event is less than a threshold fraud score, then fraud-detection system 160 may approve the request to pay out funds. Event management system 170 may then facilitate the transfer of the requested fund to the event organizer

In particular embodiments, fraud-detection system 160 may perform a variety of actions to counter improper activities once an event profile has been found fraudulent. As an example and not by way of limitation, fraud-detection system 160 may deactivate the event management account associated with the event organizer who created a fraudulent event profile. As another example and not by way of limitation, fraud-detection system 160 may stop ticket sales for an event associated with a fraudulent event profile.

In particular embodiments, fraud-detection system 160 may display the results of its evaluation of an event profile for fraud. As an example and not by way of limitation, fraud-detection system 160 may calculate a fraud score for a particular event profile and transmit that score to a client system 130, where it can be displayed by the client system 130 or viewed by a user 101. As another example and not by way of limitation, fraud-detection system 160 may transmit a fraud score to event management system 170, where it can be viewed by a system administrator. As yet another example and not by way of limitation, fraud-detection system 160 may transmit a fraud score (and possibly associated event information) to relevant law enforcement authorities. Although this disclosure describes displaying the evaluation of an event profile for fraud on particular systems, this disclosure contemplates displaying the evaluation of an event profile for fraud on any suitable system. As an example and not by way of limitation, the calculation of a fraud score may be displayed on client system 130, fraud-detection system 160, event management system 170, another suitable system, or two or more such systems.

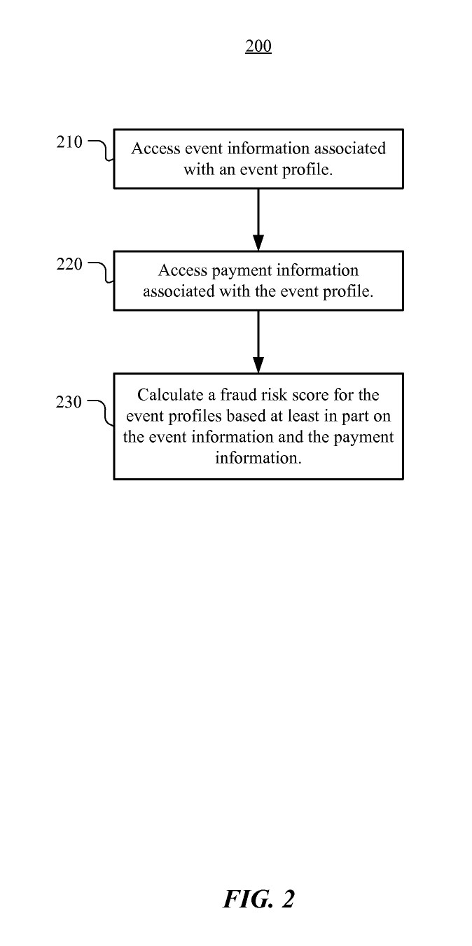

FIG. 2 illustrates an example method 200 for evaluating event profiles for fraud. The method begins at step 210, where fraud-detection system 160 may access event information associated with an event profile. The event profile may be associated with a particular event. At step 220, fraud-detection system 160 may access purchase information associated with the event profile. At step 230, fraud-detection system 160 may calculate a fraud score for the event profile based at least in part on the event information and the purchase information. At step 230, to calculate the fraud score, fraud-detection system 160 may first calculate an event quality score based on the event information and a payment quality score based on the purchase information, and then fraud-detection system 160 may calculate a fraud score based at least in part on the event quality score and the payment quality score. At step 230, fraud-detection system 160 may also access an amount of funds requested to be paid out to an event organizer and calculate the fraud score further based at least in part on the amount of funds requested to be paid out to the event organizer Although this disclosure describes and illustrates particular steps of the method of FIG. 2 as occurring in a particular order, this disclosure contemplates any suitable steps of the method of FIG. 2 occurring in any suitable order. Moreover, although this disclosure describes and illustrates particular components carrying out particular steps of the method of FIG. 2, this disclosure contemplates any suitable combination of any suitable components carrying out any suitable steps of the method of FIG. 2.

More information related to fraud and spam detection, and fraud detection systems may be found in U.S. patent application Ser. No. 12/966,104, filed 13 Dec. 2010, U.S. patent application Ser. No. 12/982,264, filed 30 Dec. 2010, and U.S. patent application Ser. No. 13/524,459, filed 15 Jun. 2012, each of which is incorporated by reference herein.

### Detecting Fraud Using an Ensemble of Fraud-Detection Algorithms

In particular embodiments, fraud-detection system 160 may facilitate classifying fraudulent event profiles in an event management system by training and/or conditioning fraud-detection algorithms on multiple selected data sets and using the trained set of algorithms on new, created, and/or modified event profiles. A fraud classification may then be generated by aggregating the fraud-probability scores from each algorithm into a cumulative score and assessing the probability that the event profile is fraudulent based on the cumulative score for each event profile. As an example and not by way of limitation, a fraudulent event profile may be created by one or more of a user, script, or any other type of computer program designed to create and/or modify event profiles. Fraud-detection system 160 may detect such fraudulent event profiles from many legitimate event profiles, while reducing the risk of classifying legitimate event profiles as fraudulent. While the teachings of the present disclosure relate to classification of event profiles, the algorithms, systems, and general processes described herewithin may be generally applicable to any data that may be susceptible to fraud and should not be limited in scope to application on and/or with event profiles.

A fraudulent event profile may be any event profile, event, message, or communication associated with event management system 170 that is designed without a legitimate purpose. Examples of fraudulent event profiles include event profiles generated in an attempt to scam or rip-off the credit card processing arm of event management system 170. Other examples may include phishing messages and/or emails sent using social networking capabilities of event management system 170. Sample data sets may include any random sampling of historical event profiles (i.e., event profiles that have been created by users of an event management system) and may include test profiles created for testing purposes. Sample data sets may include an uneven distribution of legitimate to fraudulent events. As an example and not by way of limitation, a sample data set may contain far fewer fraudulent event profiles than legitimate event profiles.

In particular embodiments, fraud-detection system 160 may generate an ensemble of fraud-detection algorithms. An ensemble includes a set of algorithms that may be either the same or different. As an example and not by way of limitation, an ensemble may include a series of equivalent algorithms, a series of different algorithms, a series of diverse algorithms that have been trained on different data sets, or any combination thereof. A class includes a label and/or identifier that identifies a particular event profile as having a certain attribute. As an example and not by way of limitation, fraud-detection system 160 may include a fraudulent class and a legitimate class (i.e., a non-fraudulent class).

In particular embodiments, fraud-detection system 160 may access event information associated with a set of event profiles. A clustering function may assign each sample from the set to a cluster. An ensemble of classifiers (e.g., logistic regressions) may then each be trained on a different cluster of event profiles. Each classifier in the ensemble may be built by sampling event profiles with replacements from the initial set of event profiles according to a predefined distribution. As an example and not by way of limitation, a distribution may be based on the number of event profiles with a certain characteristic in each cluster or a between-cluster distribution. As another example, a distribution may be based on the number of event profiles with a certain characteristic in each class or a between-class distribution. This distribution scheme may result in data sets that are considered balanced. Balanced data sets may include even distribution in terms of event profile classifications within clusters and/or sub-clusters. Classifiers from the ensemble may then be trained and/or tuned using samples from the balanced data sets. Although this disclosure describes using an ensemble of algorithms to classify data sets relating to event profiles, this disclosure contemplates using an ensemble of algorithms to classify data sets in any suitable manner.

In particular embodiments, fraud-detection system 160 may access classified event profiles for a series of events. The classified event profiles may be event profiles corresponding to prior events associated with event management system 170 that have been identified as being either fraudulent or legitimate (e.g., classified manually). Each classified event profile may have a classification that identifies whether the corresponding classified event profile is associated with fraud and one or more first parameters. As an example and not by way of limitation, fraud-detection system 160 accesses a sample set of classified event profiles that may be maintained as a testing and/or training data set. As another example and not by way of limitation, fraud-detection system 160 accesses a set of manually classified event profiles that have been positively identified as associated with fraudulent activity. Although this disclosure describes accessing classified data sets in a particular manner, this disclosure contemplates accessing any type of data set arranged in any suitable manner.

In particular embodiments, fraud-detection system 160 may sort event profiles into a plurality of clusters. As an example and not by way of limitation, fraud-detection system 160 may identify a first and second cluster. The first cluster may correspond to event profiles that have been previously associated and/or classified as fraudulent. The second cluster may correspond to event profiles that have been previously associated and/or classified as legitimate. As an example and not by way of limitation, fraudulent event profiles are maintained in order to detect future fraudulent activity. Fraud-detection system 160 sorts these fraudulent event profiles and other legitimate event profiles that are supplied. As another example and not by way of limitation, an algorithm detects fraudulent event profiles from a database containing event profiles. Fraud-detection system 160 processes the event profiles in the database and arranges the event profiles into a first cluster and a second cluster corresponding to their fraud classification. Although this disclosure describes sorting event profiles in a particular manner, this disclosure contemplates sorting event profiles in any suitable manner.

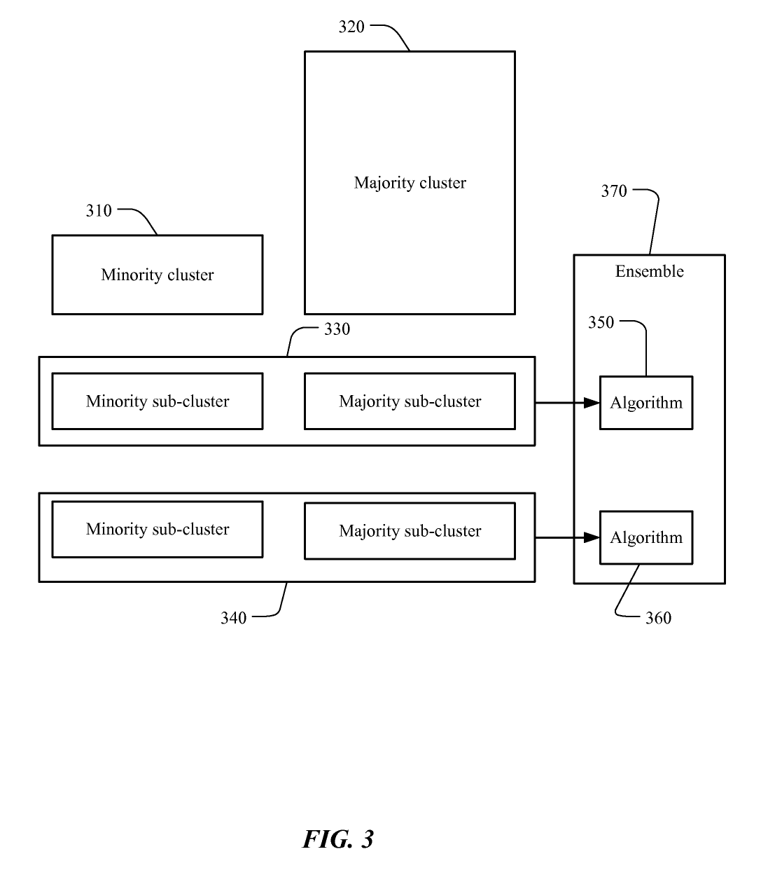

FIG. 3 illustrates an example data set cluster configuration used in a method for classifying fraud on event management systems. The data set cluster configuration may include minority cluster 310 and majority cluster 320. Minority cluster 310 may include, for example, event profiles from an event profile management system that have been classified as fraudulent via a fraud-detection system. Majority cluster 320 may include, for example, event profiles from an event profile management system that have been classified as legitimate by a fraud-detection system. In particular embodiments, minority sub-clusters may be selected from minority cluster 310 based on a selection condition (e.g., a query or other condition imposed on parameters of event profiles in minority cluster 310). Majority sub-clusters may be selected from majority cluster 320 based on a selection condition (e.g., a query or other condition imposed on parameters of event profiles in majority cluster 320).

In particular embodiments, tranches of data set sub-clusters may be submitted to an algorithm from ensemble 370 in order to train an algorithm (e.g., a fraud-detection algorithm). As an example and not by way of limitation, algorithm 350 from ensemble 370 may be trained using data from tranche 330 containing two sub-clusters (i.e., a minority sub-cluster and a majority sub-cluster). As another example, algorithm 360 from ensemble 370 is trained using data from tranche 340.

In particular embodiments, a base classification model for classifying event profiles may be selected. A clustering function may also be selected that assigns each sample to a given sub-cluster of the event profiles.

In particular embodiments, for each model in the ensemble, a sample data set from a sub-cluster of event profiles having a minority class may be chosen. This sample data set may be a bootstrap sample. The minority class may refer to a classification or identifier indicating that the event profile is fraudulent.

In particular embodiments, an equivalent sample set of event profiles is drawn from a second sub-cluster of event profiles having a majority class. The majority class may refer to a classification or identifier indicating that the event profile is legitimate.

In particular embodiments, models from the ensemble are trained on the corresponding resulting data sets. The models may optionally perform additional steps such as feature selection or computing feature combinations. Each trained model may next compute the probability of fraud for a new event profile. Fraud-detection system 160 aggregates the resulting probabilities calculated by each model and determines a final probability score. As an example and not by way of limitation, the final probability score may be calculated by using a simple average of the probabilities from each model. In certain embodiments, the final prediction may be calculated by weighting the probabilities received from each model.

In particular embodiments, large data sets containing a diverse representation of majority and minority classes are beneficial for training purposes, and may enable more accurate predictions. As an example and not by way of limitation, tree-based model data sets may be preferred for training ensemble models and/or algorithms.

In particular embodiments, fraud-detection system 160 may be beneficial in circumstances where examples of fraud are rare, and where input data sets include very diverse data. Fraud data may be typically diverse. Thus training fraud-detection algorithms on such diverse example fraudulent data sets may lead to under-sampling and/or under-detection of fraudulent transactions that do not share such diverse properties. As an example and not by way of limitation, a large number of fraudulent events may be registered to occur in a particular location a. Such characteristic information may skew algorithms trained against typical sample data sets. However, certain embodiments disclosed in connection with the present disclosure may neutralize such biases by grouping fraudulent transactions from location a with legitimate transactions from location a. Such embodiments may allow classifiers to be trained on balanced data while still accounting for characteristic biases by presenting an aggregate of scores from the ensemble of separately trained algorithms.

In particular embodiments, fraud-detection system 160 may determine a set of sub-clusters. Those of ordinary skill in the art should appreciate that small, simple quantities of sub-clusters are described in the present disclosure for explanation purposes. The number, complexity, and scope of sub-clusters, clusters, and any other grouping of event profiles may be expanded significantly without departing from the scope of the present disclosure. The sub-clusters may include selected event profiles selected from each of the clusters based on whether parameters of the event profiles contained in each of the clusters match a specified parameter. As an example and not by way of limitation, one sub-cluster may contain fraudulent event profiles from the fraudulent cluster of event profiles whose event location parameter contains country a. As another example and not by way of limitation, another sub-cluster may contain legitimate event profiles from the legitimate cluster of event profiles whose event time parameter is between 1 AM and 6 AM. Although this disclosure describes creating sub-clusters in a particular manner, this disclosure contemplates creating sub-cluster in any suitable manner. As an example and not by way of limitation, four sub-clusters may be created. The first sub-cluster may contain fraudulent event profiles having a parameter matching a specified parameter. The second sub-cluster may contain legitimate event profiles having a parameter matching the specified parameter. The third sub-cluster may contain fraudulent event profiles having a parameter matching a second specified parameter. The fourth sub-cluster may contain legitimate event profiles having a parameter matching a second specified parameter. This process may continue for each sub-cluster.

In particular embodiments, fraud-detection system 160 may condition (i.e., train) fraud detection algorithms using the sub-clusters of event profiles. The algorithms may modify and/or adapt their classification processes based on data identified as fraudulent and legitimate in order to produce more accurate classifications on unclassified event profiles. As an example and not by way of limitation, an ensemble of similar algorithms may be trained on different sub-clusters of event profiles. As another example and not by way of limitation, an ensemble of diverse algorithms may be trained on different sub-clusters of event profiles. Algorithm conditioning processes may differ with respect to implementation. Although this disclosure describes training sets of algorithms in a particular manner, this disclosure contemplates training sets of algorithms in any suitable manner.

In particular embodiments, fraud-detection system 160 may access an unclassified event profile. The unclassified event profile may have second parameters that correspond to the first parameters from the classified event profiles. As an example and not by way of limitation, a user may register an event profile and fraud-detection system 160 may access the unclassified event profile in real-time to assess the legitimacy of the event profile. As another example and not by way of limitation, quality testing may be conducted on created event profiles to make sure only legitimate event profiles are hosted on an event management site. Although this disclosure describes accessing unclassified event profiles in a particular manner, this disclosure contemplates accessing classified event profiles in any suitable manner.

In particular embodiments, fraud-detection system 160 may calculate fraud scores for the unclassified event profile using a plurality of fraud-detection algorithms. The fraud scores may be different for the unclassified event profile because each algorithm has been trained and/or conditioned using distinct groups of pre-classified data. As an example and not by way of limitation, an algorithm trained on sub-clusters containing a common country (e.g., fraudulent and legitimate event profile sub-clusters where the event parameter indicates the event occurs in Germany), will likely detect a high probability of fraud for unclassified event profiles that have similar parameter traits to those fraudulent event profiles from the training sub-cluster. A second algorithm may be trained on sub-clusters grouped by time. This second algorithm may score the same unclassified document completely different with respect to its fraud probability. As another example, and not by way of limitation, a first and second fraud-detection algorithm may produce different fraud-probability scores. The first fraud-detection algorithm may indicate a very high probability that an event profile is associated with fraudulent activity while the second fraud-detection algorithm may indicate a very low probability that the event profile is associated with fraudulent activity. Thus, since each algorithm may be trained differently, fraud-detection scores may vary based on the algorithm used within the ensemble. These varying fraud scores may be aggregated across the ensemble to produce a final fraud probability. If the final fraud probability is greater than a predetermined threshold, the unclassified event profile may be classified as fraudulent.

In particular embodiments, fraud-detection system 160 may classify an event profile based on the aggregated scores calculated by the plurality of fraud-detection algorithms. The unclassified profile may be classified by aggregating the fraud scores calculated by each fraud-detection algorithm in the ensemble of algorithms used to analyze the unclassified event. As an example and not by way of limitation, continuing with the prior example, the first and second fraud scores may be averaged to produce a single fraud score that may more accurately depict the probability of fraud of an event profile. As another example, a weighted average may be used to aggregate the fraud probability calculations from each fraud-detection algorithm.

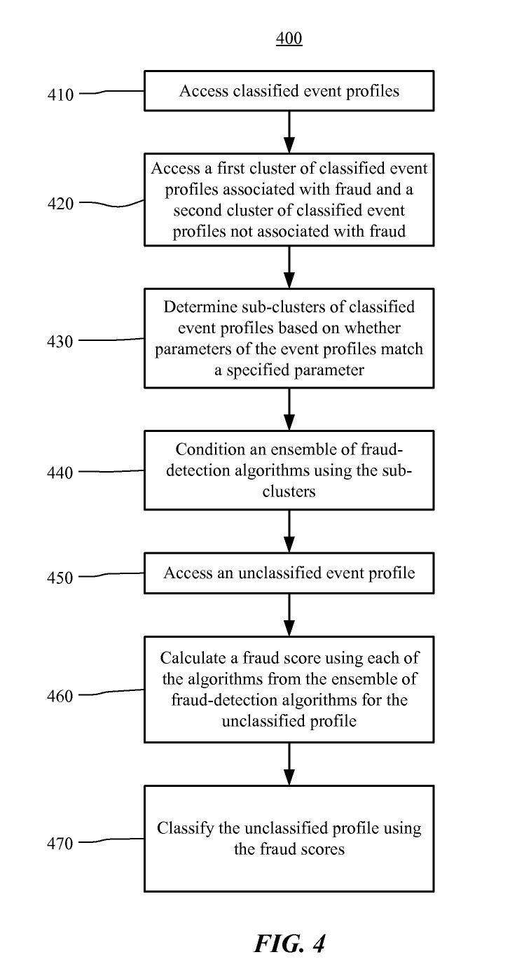

FIG. 4 illustrates an example method 400 for classifying fraud on event management system 170. The method may begin at step 410, where fraud-detection system 160 may access classified event profiles for a series of events. At step 420, fraud-detection system 160 may access a first and second cluster of event profiles. The first cluster of event profiles may be identified as being associated with fraud and the second cluster of event profiles may be identified as legitimate. At step 430, fraud-detection system 160 may determine sub-clusters. A first sub-cluster of classified event profiles from the first cluster and a second sub-cluster of classified event profiles from the second cluster may be determined based on whether parameters of the event profiles satisfy a first condition. A third sub-cluster of classified event profiles from the first cluster and a fourth sub-cluster of classified event profiles from the second cluster may be determined based on whether parameters of the event profiles satisfy a second condition. At step 440, fraud-detection system 160 may condition a first fraud-detection algorithm using the first sub-cluster and the second sub-cluster, and a second fraud-detection algorithm using the third sub-cluster and the fourth sub-cluster. In particular embodiments, execution of method 400 may terminate and/or execute other unspecified steps after completion of step 440. In particular embodiments, execution of method 400 may continue on to complete the following steps and/or other steps. At step 450, fraud-detection system 160 may access an unclassified event profile having parameters that correspond to parameters from the classified event profiles. At step 460, fraud-detection system 160 may calculate a first fraud score for the unclassified profile using the first fraud-detection algorithm and a second fraud score for the unclassified profile using the second fraud-detection algorithm. At step 470, fraud-detection system 160 may classify the unclassified profile by aggregating the first fraud score and the second fraud score to determine a classification. Particular embodiments may repeat one or more steps of the method of FIG. 4, where appropriate. As an example and not by way of limitation, many fraud-detection algorithms may be trained on many sub-clusters of classified event profiles. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates an example method for classifying fraud on event management system 170 including the particular steps of the method of FIG. 4, this disclosure contemplates any suitable method for classifying fraud on event management system 170 including any suitable steps, which may include all, some, or none of the steps of the method of FIG. 4, where appropriate. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

### Systems and Methods

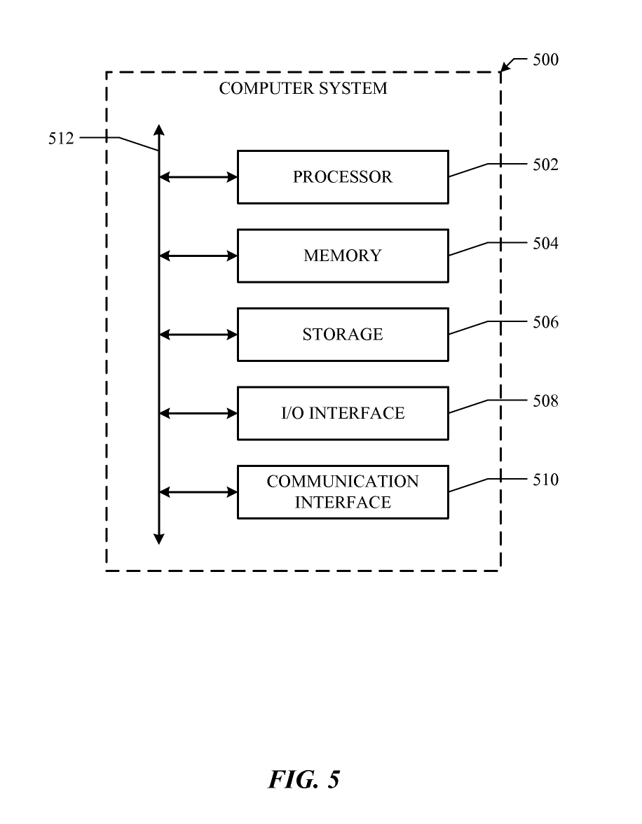

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising, by one or more processors associated with one or more computing devices:
accessing, by one or more of the processors, a plurality of classified event profiles for a plurality of events, respectively, each classified event profile comprising a classification and one or more first parameters, wherein the classification identifies whether the corresponding classified event profile is associated with fraud or legitimate;
accessing, by one or more of the processors, a first cluster of classified event profiles each identified as being associated with fraud, and a second cluster of classified event profiles each identified as being legitimate;
determining, by one or more of the processors, a plurality of first sub-clusters of classified event profiles from the first cluster of classified event profiles, and a plurality of second sub-clusters of classified event profiles from the second cluster of classified event profiles, wherein each sub-cluster comprises a plurality of classified event profiles comprising a first parameter that matches a specified parameter; and
conditioning, by one or more of the processors, a plurality of fraud-detection algorithms, each fraud-detection algorithm corresponding to a particular specified parameter, and each fraud-detection algorithm being conditioned using a first sub-cluster of classified event profiles and a second sub-cluster of classified event profiles that each comprises classified event profiles comprising a first parameter that matches the particular specified parameter of the fraud-detection algorithm.

2. The method of claim 1, further comprising:
accessing, by one or more of the processors, an unclassified event profile from the plurality of events, the unclassified event profile comprising one or more second parameters corresponding to one or more of the first parameters;
calculating, by one or more of the processors, a first fraud score for the unclassified event profile using a first fraud-detection algorithm from the plurality of fraud-detection algorithms, and a second fraud score for the unclassified event profile using a second fraud-detection algorithm from the plurality of fraud-detection algorithms; and
classifying, by one or more of the processors, the unclassified event profile by aggregating the first fraud score and the second fraud score to determine a classification for the unclassified event profile.

3. The method of claim 2, further comprising:
calculating, by one of more of the processors, a third fraud score for the unclassified event profile using an unconditioned fraud-detection algorithm, wherein classifying the unclassified event profile further comprises aggregating the third fraud score to determine the classification.

4. The method of claim 2, wherein classifying the unclassified event profile further comprises determining whether the aggregated fraud score for the unclassified event profile is greater than a threshold fraud score.

5. The method of claim 2, further comprising:
transmitting, by the one or more processors, the fraud score for the unclassified event profile for presentation to a user.

6. The method of claim 2, further comprising:
denying, using the one or more processors, requests to pay out funds associated with the unclassified event profile, wherein the classification for the unclassified event profile comprises a fraudulent classification.

7. The method of claim 1, wherein the one or more first parameters comprise: an event identifier (ID); an email address of a user; an IP address of a user; a user ID of a user; a credit card number of a user; a device ID of a user; or any combination thereof.

8. A system comprising: one or more processors; and a memory coupled to the processors comprising instructions executable by the processors, the processors operable when executing the instructions to:
accessing, by one or more of the processors, a plurality of classified event profiles for a plurality of events, respectively, each classified event profile comprising a classification and one or more first parameters, wherein the classification identifies whether the corresponding classified event profile is associated with fraud or legitimate;
accessing, by one or more of the processors, a first cluster of classified event profiles each identified as being associated with fraud, and a second cluster of classified event profiles each identified as being legitimate;
determining, by one or more of the processors, a plurality of first sub-clusters of classified event profiles from the first cluster of classified event profiles, and a plurality of second sub-clusters of classified event profiles from the second cluster of classified event profiles, wherein each sub-cluster comprises a plurality of classified event profiles comprising a first parameter that matches a specified parameter; and
conditioning, by one or more of the processors, a plurality of fraud-detection algorithms, each fraud-detection algorithm corresponding to a particular specified parameter, and each fraud-detection algorithm being conditioned using a first sub-cluster of classified event profiles and a second sub-cluster of classified event profiles that each comprises classified event profiles comprising a first parameter that matches the particular specified parameter of the fraud-detection algorithm.

9. The system of claim 8, further comprising:
accessing, by one or more of the processors, an unclassified event profile from the plurality of events, the unclassified event profile comprising one or more second parameters corresponding to one or more of the first parameters;
calculating, by one or more of the processors, a first fraud score for the unclassified event profile using a first fraud-detection algorithm from the plurality of fraud-detection algorithms, and a second fraud score for the unclassified event profile using a second fraud-detection algorithm from the plurality of fraud-detection algorithms; and
classifying, by one or more of the processors, the unclassified event profile by aggregating the first fraud score and the second fraud score to determine a classification for the unclassified event profile.

10. The system of claim 9, further comprising:
calculating, by one of more of the processors, a third fraud score for the unclassified event profile using an unconditioned fraud-detection algorithm, wherein classifying the unclassified event profile further comprises aggregating the third fraud score to determine the classification.

11. The system of claim 9, wherein classifying the unclassified event profile further comprises determining whether the aggregated fraud score for the unclassified event profile is greater than a threshold fraud score.

12. The system of claim 9, further comprising:
transmitting, by the one or more processors, the fraud score for the unclassified event profile for presentation to a user.

13. The system of claim 9, further comprising:
denying, using the one or more processors, requests to pay out funds associated with the unclassified event profile, wherein the classification for the unclassified event profile comprises a fraudulent classification.

14. The system of claim 8, wherein the one or more first parameters comprise: an event identifier (ID); an email address of a user; an IP address of a user; a user ID of a user; a credit card number of a user; a device ID of a user; or any combination thereof.

15. One or more computer-readable non-transitory storage media embodying software that is operable when executed to:
access a plurality of classified event profiles for a plurality of events, respectively, each classified event profile comprising a classification and one or more first parameters, wherein the classification identifies whether the corresponding classified event profile is associated with fraud or legitimate;
access a first cluster of classified event profiles each identified as being associated with fraud, and a second cluster of classified event profiles each identified as being legitimate;
determine a plurality of first sub-clusters of classified event profiles from the first cluster of classified event profiles, and a plurality of second sub-clusters of classified event profiles from the second cluster of classified event profiles, wherein each sub-cluster comprises a plurality of classified event profiles comprising a first parameter that matches a specified parameter; and
condition a plurality of fraud-detection algorithms, each fraud-detection algorithm corresponding to a particular specified parameter, and each fraud-detection algorithm being conditioned using a first sub-cluster of classified event profiles and a second sub-cluster of classified event profiles that each comprises classified event profiles comprising a first parameter that matches the particular specified parameter of the fraud-detection algorithm.

16. The media of claim 15, wherein the software is further operable when executed to:
access an unclassified event profile from the plurality of events, the unclassified event profile comprising one or more second parameters corresponding to one or more of the first parameters;
calculate a first fraud score for the unclassified event profile using a first fraud-detection algorithm from the plurality of fraud-detection algorithms, and a second fraud score for the unclassified event profile using a second fraud-detection algorithm from the plurality of fraud-detection algorithms; and
classify the unclassified event profile by aggregating the first fraud score and the second fraud score to determine a classification for the unclassified event profile.

17. The media of claim 16, wherein the software is further operable when executed to:
calculate a third fraud score for the unclassified event profile using an unconditioned fraud-detection algorithm, wherein classifying the unclassified event profile further comprises aggregating the third fraud score to determine the classification.

18. The media of claim 16, wherein classifying the unclassified event profile further comprises determining whether the aggregated fraud score for the unclassified event profile is greater than a threshold fraud score.

19. The media of claim 16, wherein the software is further operable when executed to:
transmit the fraud score for the unclassified event profile for presentation to a user.

20. The media of claim 16, wherein the software is further operable when executed to:
deny requests to pay out funds associated with the unclassified event profile, wherein the classification for the unclassified event profile comprises a fraudulent classification.
